(19) United States
(12) Patent Application Publication
(10) Pub. No.: US 2014/0149298 A1
(43) Pub. Date: May 29, 2014

(54) SYSTEM AND METHOD FOR DETECTING DOCUMENTS

(71) Applicant: NEXTPOINT, INC., Chicago, IL (US)

(72) Inventors: Benjamin R. Wolf, MIddleton, WI (US); James Fitzgerald Halberg, Sun Prairie, WI (US); Adam D. Olien, Madison, WI (US); Dakota Alexander Dux, Monona, WI (US); Rakesh Madhava, Chicago, CA (US)

(73) Assignee: NEXTPOINT, INC., Chicago, IL (US)

(21) Appl. No.: 13/689,059

(22) Filed: Nov. 29, 2012

(51) Int. Cl. G06Q 50/18

(52) U.S. Cl. CPC G06Q 50/18
USPC 705/311

(57) ABSTRACT

Stored trial information is accessed. A privileged document list is obtained identifying a selected set of the plurality of documents including documents identified as privileged. An unselected set is identified including documents not belonging to the selected set. A plurality of context triggered piecewise hashes is generated. At least one match likelihood value is calculated between the at least one document of the selected set and the at least one document of the unselected set based on the plurality of context triggered piecewise hashes. At least one potentially privileged document is identified in the unselected set based on the at least one match likelihood value with at least one document from the selected set. At least one of the at least one potentially privileged document is added to the privileged document list. Documents excluded from the modified privileged document list are prepared for transfer.

### BACKGROUND OF THE INVENTION

1. Field of the Invention

Embodiments of the invention described herein pertain to the field of computer systems. More particularly, but not by way of limitation, one or more embodiments of the invention enable a system and method for detecting documents.

2. Description of the Related Art

Electronic document management systems are increasingly used to manage data, such as documents. In litigation, electronic discovery is an increasingly common method for exchanging information in a digital format. Often, digital documents are generated in bulk from computers and other electronic equipment using techniques such as digital forensics analysis and/or other methods.

Some documents may be protected from discovery by opposing counsel. For example, the work-product doctrine protects materials prepared in anticipation of litigation, while the attorney-client privilege protects communications between an attorney and a client. However, the privilege may be waived by disclosure of the privileged matter. There is a risk of waiver when privileged documents are inadvertently produced.

Electronic discovery often produces a large volume of digital data that may contain exactly or nearly duplicative content. There are currently no known systems that provide a system or method for detecting documents containing nearly duplicative content contained in documents known to be privileged.

### BRIEF SUMMARY OF THE INVENTION

Systems and methods are described herein for detecting documents containing nearly duplicative content contained in documents known to be privileged.

One or more embodiments of the system and method for detecting documents described herein are directed to a method for managing trial information.

The method may include accessing stored trial information including a plurality of documents in a digital format.

The method may further include obtaining a privileged document list identifying a selected set of the plurality of documents including documents identified as privileged.

The method may further include identifying an unselected set including documents belonging to the plurality of documents and not belonging to the selected set.

The method may further include generating a plurality of context triggered piecewise hashes for at least one document of the selected set and at least one document of the unselected set.

The method may further include calculating at least one match likelihood value between the at least one document of the selected set and the at least one document of the unselected set based on the plurality of context triggered piecewise hashes.

The method may further include identifying at least one potentially privileged document in the unselected set based on the at least one match likelihood value with at least one document from the selected set.

The method may further include adding at least one of the at least one potentially privileged document to the privileged document list.

The method may further include preparing documents excluded from the modified privileged document list for transfer. In one or more embodiments, preparing the documents includes preparing the documents in a specified format for electronic production. The specified format may be compatible with a third-party electronic trial management platform.

In one or more embodiments, the method further includes displaying the at least one potentially privileged document to a user, and obtaining input from the user corresponding to at least one privilege classification. Adding the at least one potentially privileged document to the privileged document list is based on the at least one privilege classification. In one or more embodiments, the at least one privilege classification includes an indicator selected from the indicator set including non-privileged, attorney-client privilege and attorney work product. The indicator set may further include confidential.

In one or more embodiments, the method further includes transferring the prepared documents.

In one or more embodiments, the method further includes receiving a read acknowledgement from a party to whom the prepared documents are transferred, and displaying a review status based on the read acknowledgement.

In one or more embodiments, the method further includes obtaining at least one removable expression, and calculating at least one excluded context triggered piecewise hash based on the at least one removable expression. The at least one excluded context triggered piecewise hash is ignored when calculating the at least one match likelihood value between the at least one document of the selected set and the at least one document of the unselected set.

In one or more embodiments, the method further includes obtaining at least one removable expression. The at least one removable expression is excluded when generating the plurality of context triggered piecewise hashes for the at least one document of the selected set and the at least one document of the unselected set.

One or more embodiments of the system and method for detecting documents described herein are directed to a computer readable medium including computer readable instructions for managing trial information.

Execution of the computer readable instructions by one or more processors may cause the one or more processors to access stored trial information including a plurality of documents in a digital format.

Execution of the computer readable instructions by one or more processors may further cause the one or more processors to obtain a privileged document list identifying a selected set of the plurality of documents including documents identified as privileged.

Execution of the computer readable instructions by one or more processors may further cause the one or more processors to identify an unselected set including documents belonging to the plurality of documents and not belonging to the selected set.

Execution of the computer readable instructions by one or more processors may further cause the one or more processors to generate a plurality of context triggered piecewise hashes for at least one document of the selected set and at least one document of the unselected set.

Execution of the computer readable instructions by one or more processors may further cause the one or more processors to calculate at least one match likelihood value between the at least one document of the selected set and the at least one document of the unselected set based on the plurality of context triggered piecewise hashes.

Execution of the computer readable instructions by one or more processors may further cause the one or more processors to identify at least one potentially privileged document in the unselected set based on the at least one match likelihood value with at least one document from the selected set.

Execution of the computer readable instructions by one or more processors may further cause the one or more processors to display the at least one potentially privileged document to a user.

Execution of the computer readable instructions by one or more processors may further cause the one or more processors to obtain input from the user corresponding to at least one privilege classification.

Execution of the computer readable instructions by one or more processors may further cause the one or more processors to add at least one of the at least one potentially privileged document to the privileged document list based on the at least one privilege classification. In one or more embodiments, the at least one privilege classification includes an indicator selected from the indicator set including non-privileged, attorney-client privilege and attorney work product. The indicator set may further include confidential.

Execution of the computer readable instructions by one or more processors may further cause the one or more processors to prepare documents excluded from the modified privileged document list for transfer. In one or more embodiments, preparing the documents includes preparing the documents in a specified format for electronic production. The specified format may be compatible with a third-party electronic trial management platform.

In one or more embodiments, execution of the computer readable instructions by one or more processors may further cause the one or more processors to securely transfer the prepared documents to another party registered with the third-party electronic trial management platform.

In one or more embodiments, execution of the computer readable instructions by one or more processors may further cause the one or more processors to securely transfer the prepared documents to another party.

In one or more embodiments, execution of the computer readable instructions by one or more processors may further cause the one or more processors to receive a read acknowledgement from the party to whom the prepared documents are transferred, and display a review status based on the read acknowledgement.

In one or more embodiments, execution of the computer readable instructions by one or more processors may further cause the one or more processors to obtain at least one removable expression, and calculate at least one excluded context triggered piecewise hash based on the at least one removable expression. The at least one excluded context triggered piecewise hash is ignored when calculating the at least one match likelihood value between the at least one document of the selected set and the at least one document of the unselected set.

In one or more embodiments, execution of the computer readable instructions by one or more processors may further cause the one or more processors to obtain at least one removable expression. The at least one removable expression is excluded when generating the plurality of context triggered piecewise hashes for the at least one document of the selected set and the at least one document of the unselected set.

### BRIEF DESCRIPTION OF THE DRAWINGS

The above and other aspects, features and advantages of the invention will be more apparent from the following more particular description thereof, presented in conjunction with the following drawings wherein:

FIG. 1 illustrates a general-purpose computer and peripherals that when programmed as described herein may operate as a specially programmed computer capable of implementing one or more systems and/or methods for detecting documents described herein.

FIG. 2 illustrates an exemplary user interface for setting up a document production in accordance with one or more systems and/or methods for detecting documents described herein.

FIG. 3 illustrates an exemplary user interface for setting up a document production in accordance with one or more systems and/or methods for detecting documents described herein.

FIG. 4 illustrates an exemplary user interface for obtaining at least one removable expression in accordance with one or more systems and/or methods for detecting documents described herein.

FIGS. 5A-5B illustrate exemplary user interfaces for displaying documents detected in accordance with one or more systems and/or methods for detecting documents described herein.

FIG. 6 illustrates an exemplary user interface for managing document detection in accordance with one or more systems and/or methods for detecting documents described herein.

FIG. 7 illustrates an exemplary user interface for finalizing a document production in accordance with one or more systems and/or methods for detecting documents described herein.

FIG. 8 illustrates an exemplary notification in accordance with one or more systems and/or methods for detecting documents described herein.

FIG. 9 illustrates an exemplary user interface after a document production in accordance with one or more systems and/or methods for detecting documents described herein.

FIG. 10 illustrates an exemplary user interface for receiving a document production in accordance with more systems and/or methods for detecting documents described herein.

FIG. 11 illustrates a flowchart for an exemplary method for managing trial information in accordance with one or more systems and/or methods for detecting documents described herein.

FIG. 12 illustrates a flowchart for an exemplary method for managing trial information in accordance with one or more systems and/or methods for detecting documents described herein.

### DETAILED DESCRIPTION

A system and method for detecting documents will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. Furthermore, although steps or processes are set forth in an exemplary order to provide an understanding of one or more systems and methods, the exemplary order is not meant to be limiting. One of ordinary kill in the art would recognize that the steps or processes may be performed in a different order, and that one or more steps or processes may be performed simultaneously or in multiple process flows without departing from the spirit or the scope of the invention. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

For a better understanding of the disclosed embodiment, its operating advantages, and the specified object attained by its uses, reference should be made to the accompanying drawings and descriptive matter in which there are illustrated exemplary disclosed embodiments. The disclosed embodiments are not intended to be limited to the specific forms set forth herein. It is understood that various omissions and substitutions of equivalents are contemplated as circumstances may suggest or render expedient, but these are intended to cover the application or implementation.

The term “first”, ‘second” and the like, herein do not denote any order, quantity or importance, but rather are used to distinguish one element from another, and the terms “a” and “an” herein do not denote a limitation of quantity, but rather denote the presence of at least one of the referenced item.

One or more embodiments described herein may be fully or partially integrated with a trial management system such as the trial management systems described in U.S. patent application Ser. No. 12/098,317, filed on Apr. 4, 2008, entitled “METHOD AND SYSTEM FOR INFORMATION MANAGEMENT,” which is incorporated herein by reference in its entirety.

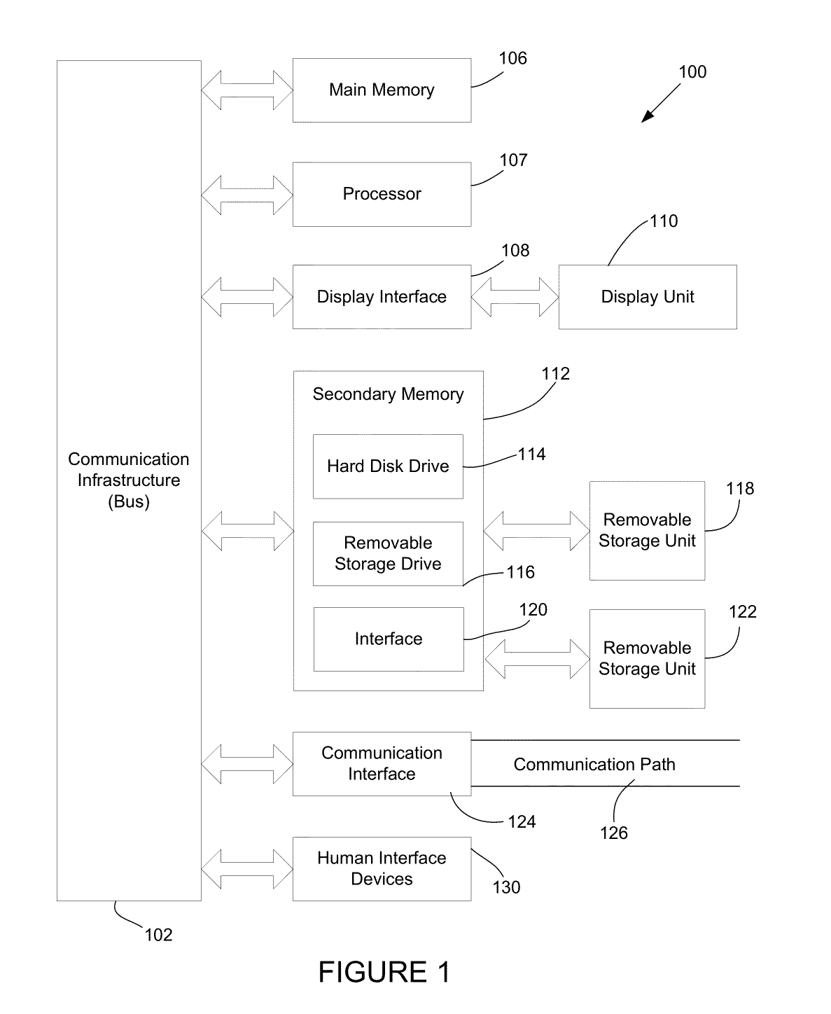

FIG. 1 diagrams a general-purpose computer and peripherals, when programmed as described herein, may operate as a specially programmed computer capable of implementing one or more methods, apparatus and/or systems of the solutions described in this disclosure. Processor 107 may be coupled to bi-directional communication infrastructure 102 such as communication infrastructure system bus 102. Communication infrastructure 102 may generally be a system bus that provides an interface to the other components in the general-purpose computer system such as processor 107, main memory 106, display interface 108, secondary memory 112 and/or communication interface 124.

Main memory 106 may provide a computer readable medium for accessing and executed stored data and applications. Display interface 108 may communicate with display unit 110 that may be utilized to display outputs to the user of the specially-programmed computer system. Display unit 110 may comprise one or more monitors that may visually depict aspects of the computer program to the user. Main memory 106 and display interface 108 may be coupled to communication infrastructure 102, which may serve as the interface point to secondary memory 112 and communication interface 124. Secondary memory 112 may provide additional memory resources beyond main memory 106, and may generally function as a storage location for computer programs to be executed by processor 107. Either fixed or removable computer-readable media may serve as Secondary memory 112. Secondary memory 112 may comprise, for example, hard disk 114 and removable storage drive 116 that may have an associated removable storage unit 118. There may be multiple sources of secondary memory 112 and systems implementing the solutions described in this disclosure may be configured as needed to support the data storage requirements of the user and the methods described herein. Secondary memory 112 may also comprise interface 120 that serves as an interface point to additional storage such as removable storage unit 122. Numerous types of data storage devices may serve as repositories for data utilized by the specially programmed computer system. For example, magnetic, optical or magnetic-optical storage systems, or any other available mass storage technology that provides a repository for digital information may be used.

Communication interface 124 may be coupled to communication infrastructure 102 and may serve as a conduit for data destined for or received from communication path 126. A network interface card (NIC) is an example of the type of device that once coupled to communication infrastructure 102 may provide a mechanism for transporting data to communication path 126. Computer networks such as Local Area Networks (LAN), Wide Area Networks (WAN), Wireless networks, optical networks, distributed networks, the Internet or any combination thereof are some examples of the type of communication paths that may be utilized by the specially program computer system. Communication path 126 may comprise any type of telecommunication network or interconnection fabric that can transport data to and from communication interface 124.

To facilitate user interaction with the specially programmed computer system, one or more human interface devices (HID) 130 may be provided. Some examples of HIDs that enable users to input commands or data to the specially programmed computer may comprise a keyboard, mouse, touch screen devices, microphones or other audio interface devices, motion sensors or the like, as well as any other device able to obtain any kind of human input and in turn communicate that input to processor 107 to trigger one or more responses from the specially programmed computer are within the scope of the system disclosed herein.

While FIG. 1 depicts a physical device, the scope of the system may also encompass a virtual device, virtual machine or simulator embodied in one or more computer programs executing on a computer or computer system and acting or providing a computer system environment compatible with the methods and processes of this disclosure. In one or more embodiments, the system may also encompass a cloud computing system or any other system where shared resources, such as hardware, applications, data, or any other resource are made available on demand over the Internet or any other network. In one or more embodiments, the system may also encompass parallel systems, multi-processor systems, multi-core processors, and/or any combination thereof. Where a virtual machine, process, device or otherwise performs substantially similarly to that of a physical computer system, such a virtual platform will also fall within the scope of disclosure provided herein, notwithstanding the description herein of a physical system such as that in FIG. 1.

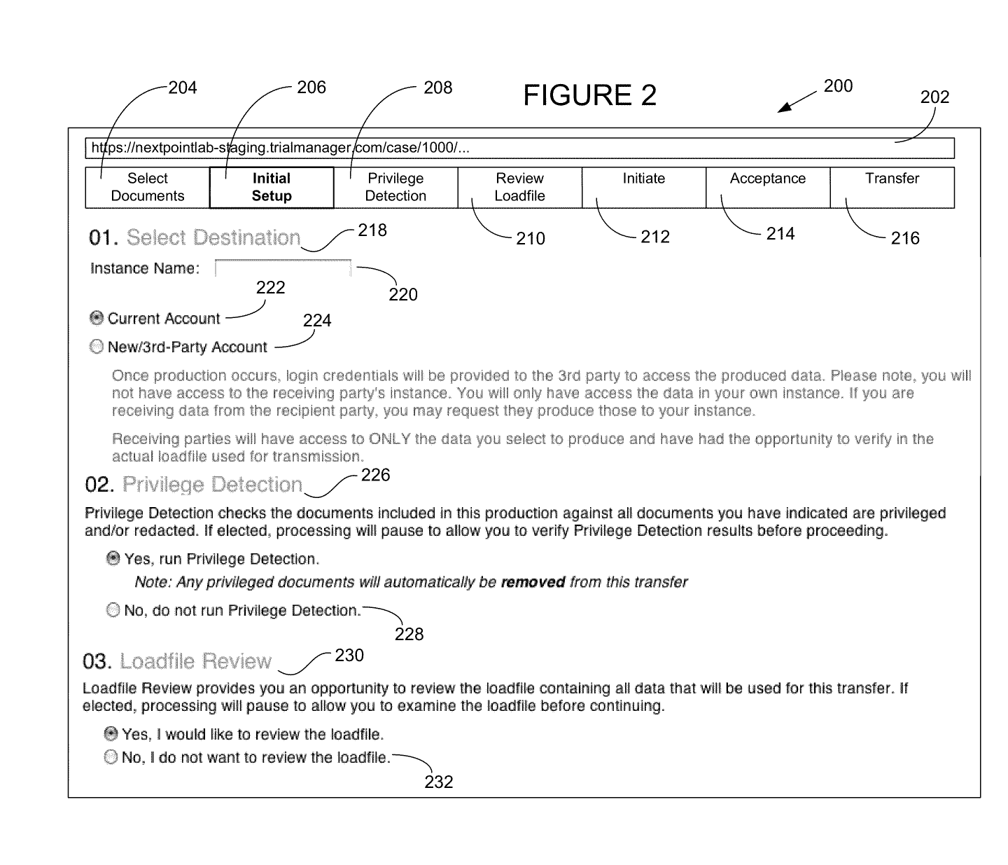

FIG. 2 illustrates an exemplary user interface for setting up a document production in accordance with one or more systems and/or methods for detecting documents described herein. User interface 200 is an exemplary user interface for an exemplary trial management system that integrates one or more systems and/or methods for document detection. In one or more embodiments, the trial management system is a web-based trial management system.

In one or more embodiments, user interface 200 is displayed in a browser capable of displaying content over a computer network, such as Local Area Networks (LAN), Wide Area Networks (WAN), Wireless networks, optical networks, distributed networks, the Internet or any combination thereof. User interface 200 may be accessed via uniform resource locator (URL) 202. In one or more embodiments, any of the user interface is shown in FIGS. 2-10 may be displayed in a browser and/or over a computer network as shown in FIG. 2.

Exemplary user interface 200 may include one or more workflow steps 204-216 corresponding to a workflow for document transfer including one or more document detection steps. In the nonlimiting example shown, the workflow is divided into steps “Select Documents” 204, “Initial Setup” 206, “Privilege Detection” 208, “Review Loadfile” 210, “Initiate” 212, “Acceptance” 214, and “Transfer” 216. Workflow steps 204-216 may be displayed as one or more user interface elements comprising links, such as one or more links to an additional URL configured to execute a portion of the workflow for document transfer.

In exemplary user interface 200, a workflow step for “Initial Setup” 206 is selected. Although a user interface for initial setup is shown, one of ordinary skill in the art would appreciate that any method of obtaining initial setup information (including but not limited to information obtained from user interfaces shown in FIGS. 2-4), such as a script, a configuration file, database information, or data from any other input source may be used without departing from the spirit or the scope of the invention.

“Initial Setup” 206 includes a destination interface 218 for selecting a file transfer destination. Destination interface 218 may include one or more text boxes 220 configured to accept any text input usable to identify a file transfer destination, such as a entity name, a user account, an address, a setup file identifier, or any text usable to identify a file transfer destination. In one or more embodiments, the trial management system is capable of executing a file transfer to another account within the trial management system, or a third-party account outside of the trial management system. Destination interface 218 may include one or more user interface elements 222-224 indicating whether the file transfer destination is to another account within the same trial management system or a third-party account outside of the current trial management system.

“Initial Setup” 206 may further include privilege detection interface 226. Privilege detection interface 226 is configured to give a user one or more options to run a document detection system and/or method. In one or more embodiments, the document detection is configured to use documents identified as privileged in the trial management system to detect potentially privileged documents selected for transfer that are not identified as privileged. In one or more embodiments, the document detection is configured to use redacted text in the trial management system to detect documents selected for transfer that should be potentially redacted. In one or more embodiments, privilege detection interface 226 may include one or more user interface elements 228 configured to bypass the document detection system and/or method.

“Initial Setup” 206 may further include loadfile review interface 230. Loadfile user interface 230 is configured to give a user one or more options to review a loadfile corresponding to the document transfer. As used herein, the term “loadfile” refers to any files containing data describing a data import, export, or other transfer. For example, a loadfile may include one or more commands or references relating to data and/or metadata. A loadfile may be formatted in a standard and/or proprietary format compatible with one or more trial management systems. In one or more embodiments, loadfile review interface 230 may include one or more user interface elements 232 configured to bypass one or more loadfile review steps.

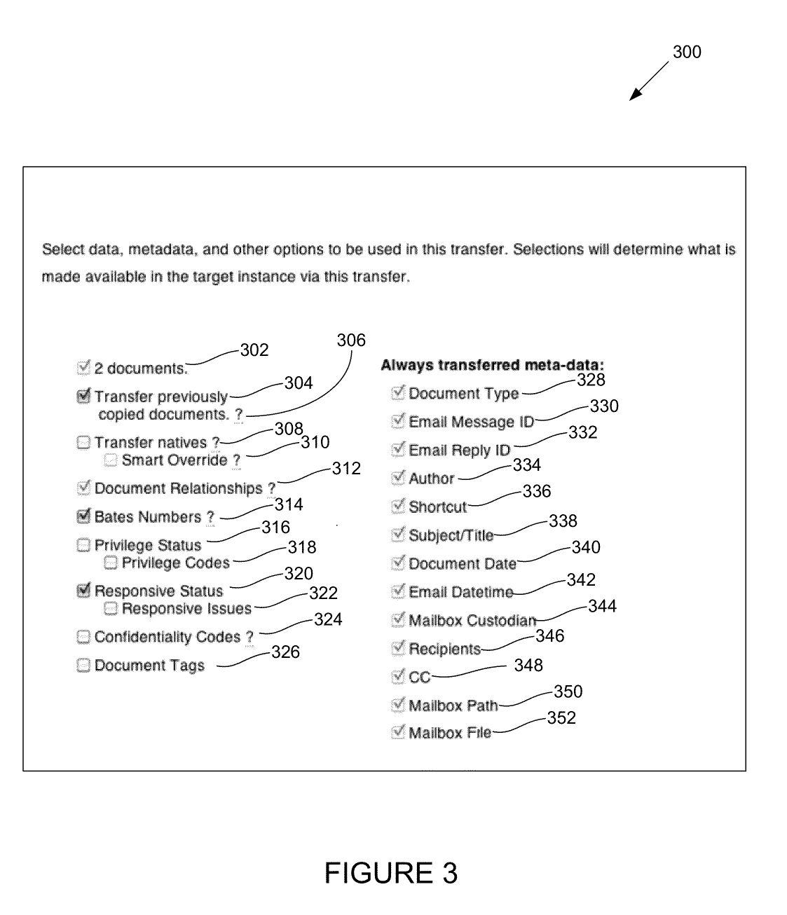

FIG. 3 illustrates an exemplary user interface for setting up a document production in accordance with one or more systems and/or methods for detecting documents described herein. Data option interface 300 may include one or more data transfer options 302-352. In data option interface 300, the following nonlimiting data transfer options are shown:

Document count 302: indicates the number of documents selected for transfer

Transfer previously copied documents 304: indicates whether documents previously copied in any manner should be transferred

Transfer natives 308: indicates whether native file formats should be transferred

Smart override 310: when this option is selected, a selection to transfer natives (308) may be overridden in certain situations where the transfer of natives is undesirable, including but not limited to: (1) the native contains unredacted blocks; (2) the native contains data necessary to create a document that is not included in the transfer; and/or (3) the data contains the data necessary to create a document that is included in this set, but is marked is privileged and/or redacted.

Document relationships 312: indicates whether the relationship between produced documents should be transferred

Bates numbers 314: indicates whether to include Bates numbers and/or whether to assign Bates numbers to unassigned documents

Privileged status 316: indicates whether a privilege status associated with documents should be transferred

Privilege codes 318: indicates whether the privilege code associated with documents should be transferred

Responsive status 320: indicates whether information corresponding to the responsiveness of documents should be transferred, such as whether one or more document is responsive to one or more discovery requests

Responsive issues 322: indicates whether detailed information corresponding to the responsiveness of documents should be transferred, such as whether one or more document is responsive to one or more specific issues

Confidentiality codes 324: indicates whether one or more confidentiality code should be transferred

Document tags 326: indicates whether document tags should be transferred

Data option interface 300 may further include one or more information interfaces 306 configured to display more information about one or more of data transfer options 302-352. In one or more embodiments, information interfaces 306 are configured to display a pop-up providing information on one or more data transfer options corresponding to the selected information interface 306.

In one or more embodiments, data option interface 300 includes one or more user interface elements 328-352 corresponding to whether the corresponding metadata type is transferred in the document production. Exemplary metadata types may include: document type 328, email message ID 330, email reply ID 332, author 334, shortcut 336, subject/title 338, document date 340, email datetime 342, mailbox custodian 344: recipient 346, CC 348, mailbox path 350, mailbox file 352, and/or any other metadata type that may be selected for transfer or non-transfer in a document production.

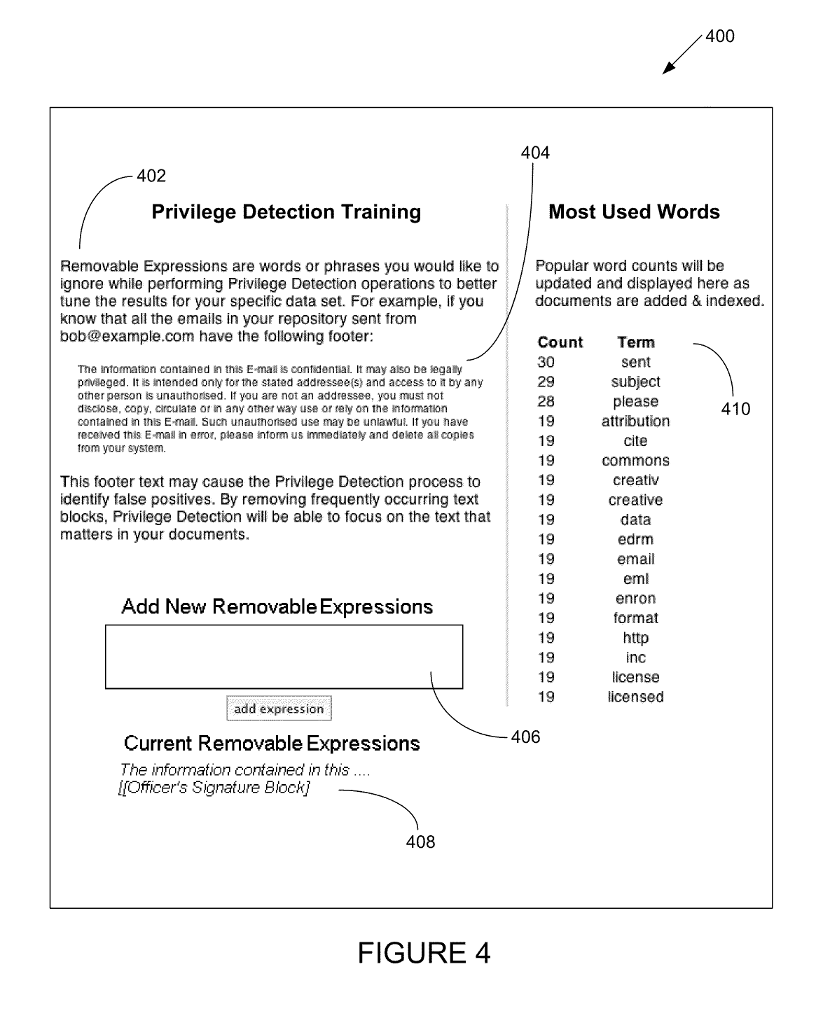

FIG. 4 illustrates an exemplary user interface for obtaining at least one removable expression in accordance with one or more systems and/or methods for detecting documents described herein. The at least one removable expression may be obtained from a database, from one or more designated files, and/or via a user interface configured to accept input from a user, or from any other input source.

Removable expression interface 400 is configured to accept one or more removable expressions. Removable expressions may include words or phrases that are known to commonly occur in the stored trial information, such as headers, footers, notices, titles, labels, names, and other words or phrases that are repeated in the stored trial information. In one or more preferred embodiments, the at least one removable expression improves the detection of privileged documents that are not marked as privileged. The at least one removable expression may also improve the detection of redactable documents that are not redacted. The removable expressions may be added or removed to perform one or more iterations of privileged document detection to improve the detection of privileged documents and/or redactable documents.

Removable expression interface 400 may include instructions 402 and/or one or more example expressions 404. Removable expression interface 400 further includes entry interface 406 for adding one or more removable expressions. Entry interface 406 may include one or more text boxes for entering the removable expressions. In one or more embodiments, removable expression interface 400 further displays current removable expressions 408. Removable expression interface 400 may further include one or more interfaces for removing a listed current removable expression 408.

Removable expression interface 400 may further display recurring phrases 410. In one or more embodiments, recurring phrases 410 is limited to recurring words occurring in the documents of the current account the trial management system. The recurring words may further be limited to recurring words occurring in the documents selected for transfer. In one or more embodiments, recurring phrases 410 further includes multi-word phrases that occur commonly in the document set. Recurring phrases 410 may assist the user in determining removable expressions to add.

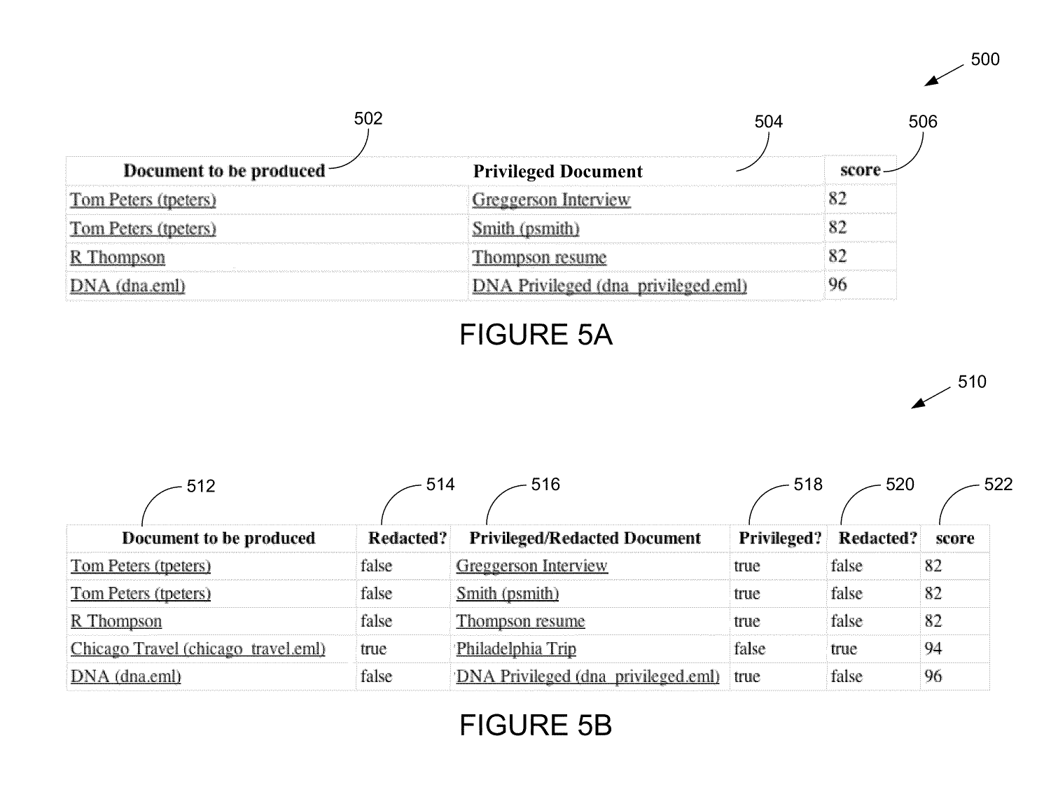

FIGS. 5A-5B illustrate exemplary user interfaces for displaying documents detected in accordance with one or more systems and/or methods for detecting documents described herein. Nonprivileged documents selected for transfer are evaluated to detect potentially privileged documents based on documents identified as privileged. The potentially privileged documents are determined by comparing a plurality of context triggered piecewise hashes generated for the nonprivileged documents and the privileged documents.

FIG. 5A illustrates exemplary document listing 500 displaying potentially privileged documents. Document listing 500 displays data corresponding to at least one document. The data may be displayed in a tabular format. Although a tabular format is shown, one of ordinary skill in the art would appreciate that any format for displaying the information may be used without departing from the spirit or the scope of the invention. Column 502 is configured to display identifying information, such as the name of a potentially privileged document. In one or more embodiments, column 502 is configured to display a link to display the potentially privileged document.

Document listing 500 may further include column 504. Column 504 is configured to display identifying information, such as the name of a privileged document corresponding to the potentially privileged document displayed in column 502. For example, the determination that the potentially privileged document in 502 is potentially privileged may be based on a comparison to the privileged document in column 504. In one or more embodiments, multiple privileged documents may be displayed in column 504 for each potentially privileged document in column 502. In one or more embodiments, column 504 is configured to display a link to display the privileged document.

Document listing 500 may further include column 506. Column 506 is configured to display a match likelihood value calculated between the potentially privileged document of column 502 and one or more privileged documents displayed in column 504. The match likelihood value is calculated based the plurality of context triggered piecewise hashes generated for each document. The match likelihood values correspond to a similarity between a document designated as privileged and a document not designated as privileged.

FIG. 5B illustrates exemplary document listing 510 displaying potentially privileged documents and/or documents that should be redacted. Document listing 510 displays data corresponding to at least one document. The data may be displayed in a tabular format. Although a tabular format is shown, one of ordinary skill in the art would appreciate that any format displaying the information may be used without departing from the spirit or the scope of the invention. Column 512 is configured to display identifying information, such as the name of a potentially privileged document and/or a potentially redactable document. A potentially redact double document contains unredacted information that is redacted in one or more other documents, such as a redacted document stored in the trial management system. In one or more embodiments, column 512 is configured to display a link to display the document.

Document listing 510 may further include column 514. Column 514 is configured to display whether a document listed in column 512 is redacted. For example, column 514 may display an indicator of whether the document in column 512 has been previously reviewed for redaction. Column 514 may alternatively display an indicator of whether the document in column 512 contains redacted portions.

Document listing 510 may further include column 516. Column 516 is configured to display identifying information, such as the name of a privileged document or a redacted document corresponding to the document displayed in column 512. For example, the determination that the document in 512 is potentially privileged and/or potentially redactable may be based on a comparison to the document in column 516. In one or more embodiments, multiple documents may be displayed in column 516 for each document in column 512. In one or more embodiments, column 516 is configured to display a link to display the privileged document.

Document listing 510 may further include columns 518 and column 520. Column 518 is configured to display an indicator of whether the document in column 516 is privileged. Column 520 is configured to display an indicator of whether the document in column 516 is redacted.

Document listing 510 may further include column 522. Column 522 is configured to display a match likelihood value calculated between the potentially privileged and/or potentially retractable document of column 512 and the redacted and/or privileged documents displayed in column 516. The match likelihood value is calculated based the plurality of context triggered piecewise hashes generated for each document.

In one or more embodiments, a user interface is displayed to a user to obtain user input regarding the proper designation of the potentially privileged documents of columns 502 and 512. At least one potentially privileged document may be displayed to a user, and input from the user may be accepted that corresponds to at least one privilege classification for a potentially privileged document. For example, the privilege classification may include non-privileged, attorney-client privilege, attorney work product, and/or confidential. In addition to displaying potentially privileged documents, other information may be displayed, such as a match likelihood value, the one or more privileged documents that highly match the potentially privileged document, metadata associated with either the potentially privileged document and/or the known privileged document, whether either document is redacted, or any other information useful for the user to determine whether the document is privileged.

In one or more embodiments, a user interface is provided to accept one or more redaction to a potentially redactable document of columns 502 and 512. The user interface may be further configured to suggest one or more suggested redactions based on one or more comparisons between the potentially redact double document and one or more redacted documents.

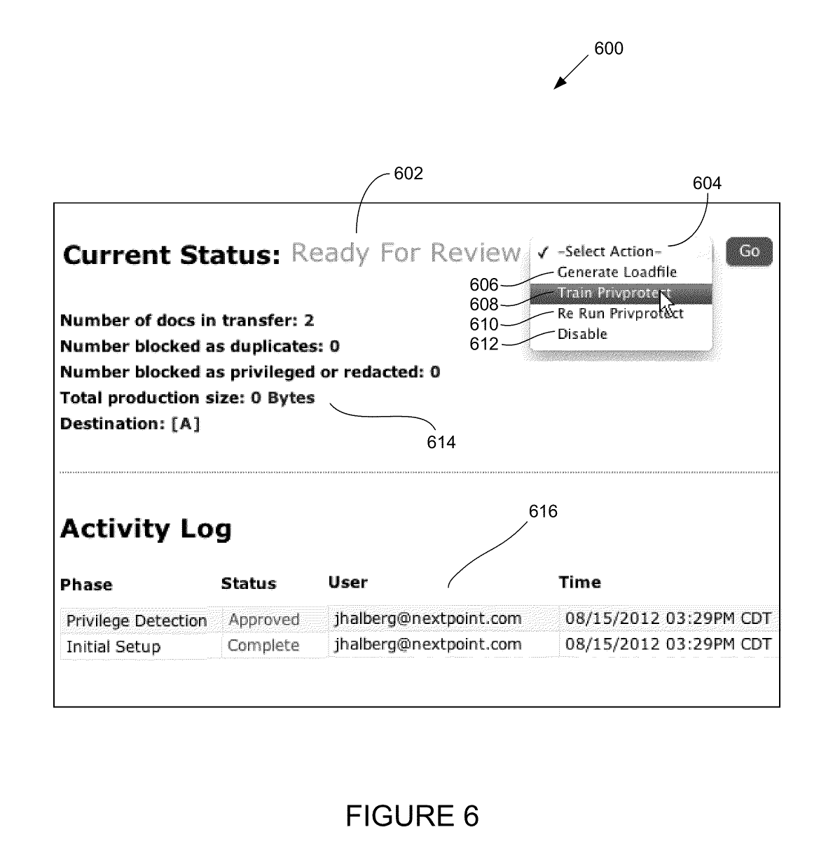

FIG. 6 illustrates an exemplary user interface for managing document detection in accordance with one or more systems and/or methods for detecting documents described herein. Exemplary transfer interface 600 includes status 602. In the currently displayed view of transfer interface 600, status 602 indicates that the file transfer is ready for review.

Exemplary transfer interface 600 further includes action interface 604. Action interface 604 allows a user to select one or more actions 606-612. When exemplary action 606 is selected, a loadfile is generated. Typically, exemplary action 606 is selected after a file transfer is reviewed and ready for transfer.

When exemplary action 608 is selected, parameters for document detection may be modified, thereby improving the document detection systems and/or methods. Document detection may be performed iteratively to improve document detection results. In one or more embodiments, exemplary action 608 allows a user to modify removable expressions, as exemplified in FIG. 4. Other parameters may be modified, such as threshold match likelihood values, matching sensitivity, documents identified as privileged, or any other parameter that may affect a result of one or more systems and/or methods for document detection described herein. When exemplary action 610 is selected, document detection may be run again. In one or more embodiments, exemplary actions 610 is selected after modifying one or more parameters for document detection, including but not limited to modifying removable expressions, threshold match likelihood values, matching sensitivity, documents identified as privileged, or any other parameter that may affect a result of one or more systems and/or methods for document detection described herein. When exemplary action 612 is selected, one or more systems and/or methods for document detection are bypassed.

Exemplary transfer interface 600 may further include file transfer information 614. File transfer information 614 may include information describing the file transfer, such as the number of documents transferred, the number of documents acted as duplicates, the number of documents locked as privileged, the number of documents blocked is redacted, a total file size, a file transfer destination, or any other information pertaining to the file transfer.

Exemplary transfer interface 600 may further include activity log 616. Activity log 616 may include information pertaining to one or more steps of the file transfer, which may include one or more steps relating to systems and/or methods for document detection described herein. For example, activity log 660 may include workflow information, status information, user information, timestamp information, and/or any other information suitable for inclusion in an activity log relating to file transfer.

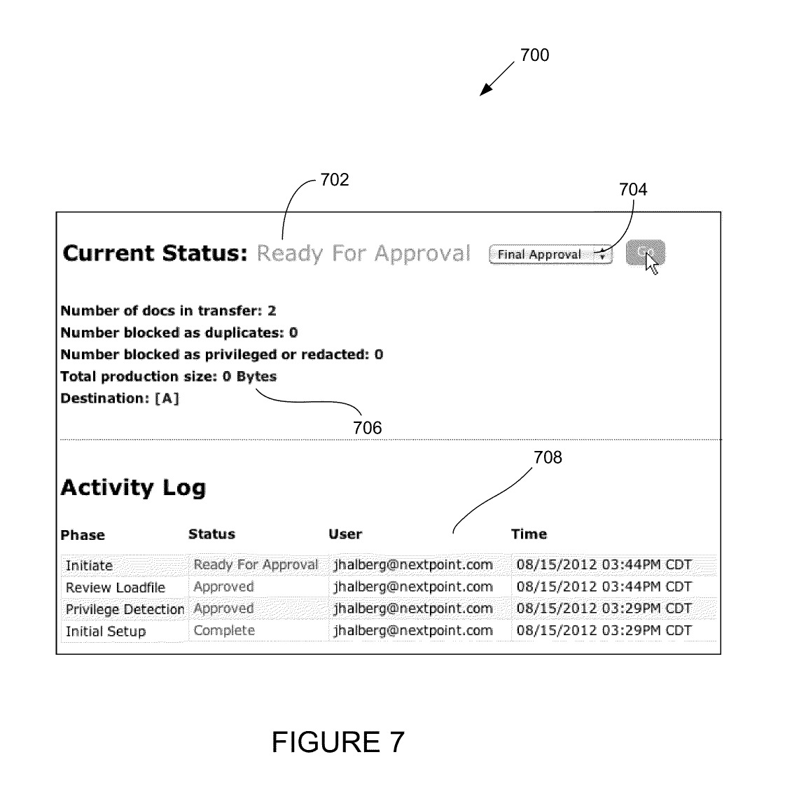

FIG. 7 illustrates an exemplary user interface for finalizing a document production in accordance with one or more systems and/or methods for detecting documents described herein. Exemplary transfer interface 700 includes status 702. In the currently displayed view of transfer interface 700, status 702 indicates that the file transfer is ready for final approval. Exemplary transfer interface 700 may further include approval interface 704 configured to allow a user to affirm that the file transfer is ready to transfer. In one or more embodiments, exemplary transfer interface 700 further includes file transfer information 706 and/or activity log 708.

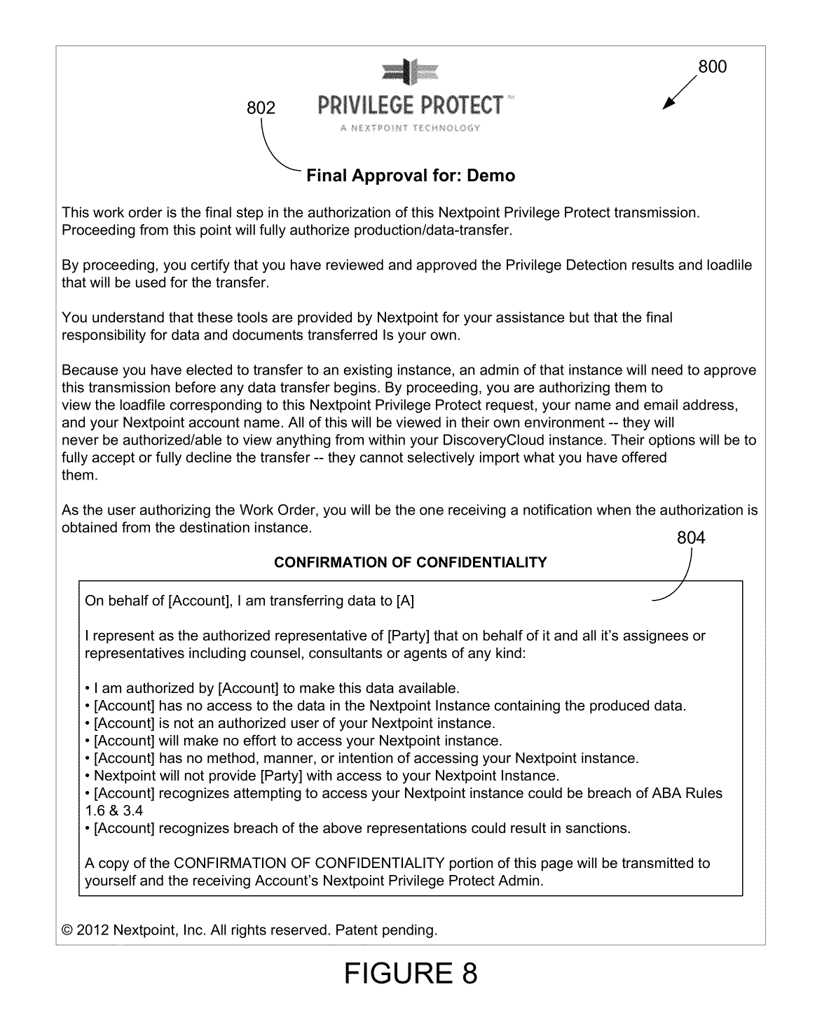

FIG. 8 illustrates an exemplary notification in accordance with one or more systems and/or methods for detecting documents described herein. Exemplary notification 800 may include dialogue 802 explaining the transfer process. Exemplary notification 800 may further include confidentiality confirmation 804. Confidentiality confirmation 804 may require a user initiating the transfer to agree to one or more confidentiality clauses. In one or more embodiments, the user is required to confirm that they are an authorized representative of an entity for whom the transfer is executed.

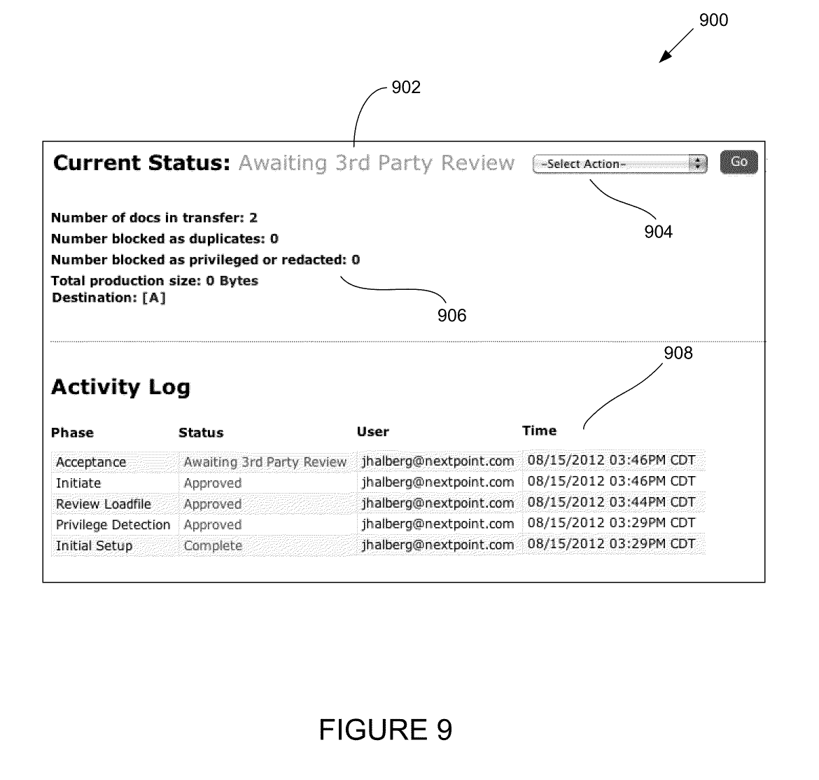

FIG. 9 illustrates an exemplary user interface after a document production in accordance with one or more systems and/or methods for detecting documents described herein. Exemplary transfer interface 900 includes status 902. In one or more embodiments, the recipient of the file transfer is another trial management system account, which may be an account within the same trial management system or a third-party account outside of the trial management system. The receiving party may have a chance to review a summary, such as a loadfile, corresponding to the transfer before accepting or rejecting the transfer.

In the currently displayed view of transfer interface 900, status 902 indicates that the executed file transfer is awaiting review by the recipient of the file transfer. Status 902 may indicate that the file transfer has been accepted after acknowledgement is received from the recipient. In one or more embodiments, exemplary transfer interface 900 further includes file transfer information 906 and/or activity log 908.

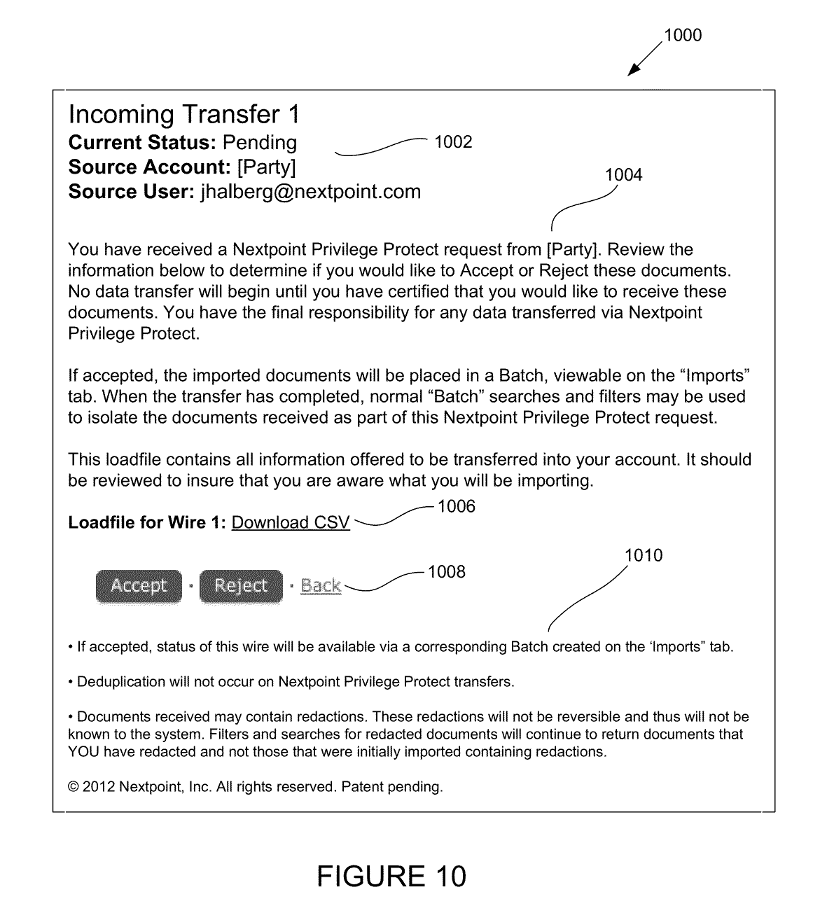

FIG. 10 illustrates an exemplary user interface for receiving a document production in accordance with more systems and/or methods for detecting documents described herein. Exemplary receiving interface 1000 is shown to a recipient of a file transfer described herein. Exemplary receiving interface 1000 may include incoming transfer information 1002. Incoming transfer information 1002 may include information describing an incoming file transfer, such as a transfer name, transfer status, transfer source, transferred source user, or any other information describing an incoming file transfer. In one or more embodiments, the incoming transfer is a production of documents in a litigation proceeding. Exemplary receiving interface 1000 may include dialogue 1004 describing the incoming transfer procedure.

Exemplary receiving interface 1000 may further include review data at 1006. The receiving party may have a chance to review a summary, such as a loadfile, corresponding to the transfer before accepting or rejecting the transfer. Exemplary receiving interface 1000 may further include acceptance interface 1008 configured to allow a recipient to accept or reject the incoming file transfer. Exemplary receiving interface 1000 may further include dialogue 1010 describing the acceptance procedure following acceptance of an incoming file transfer.

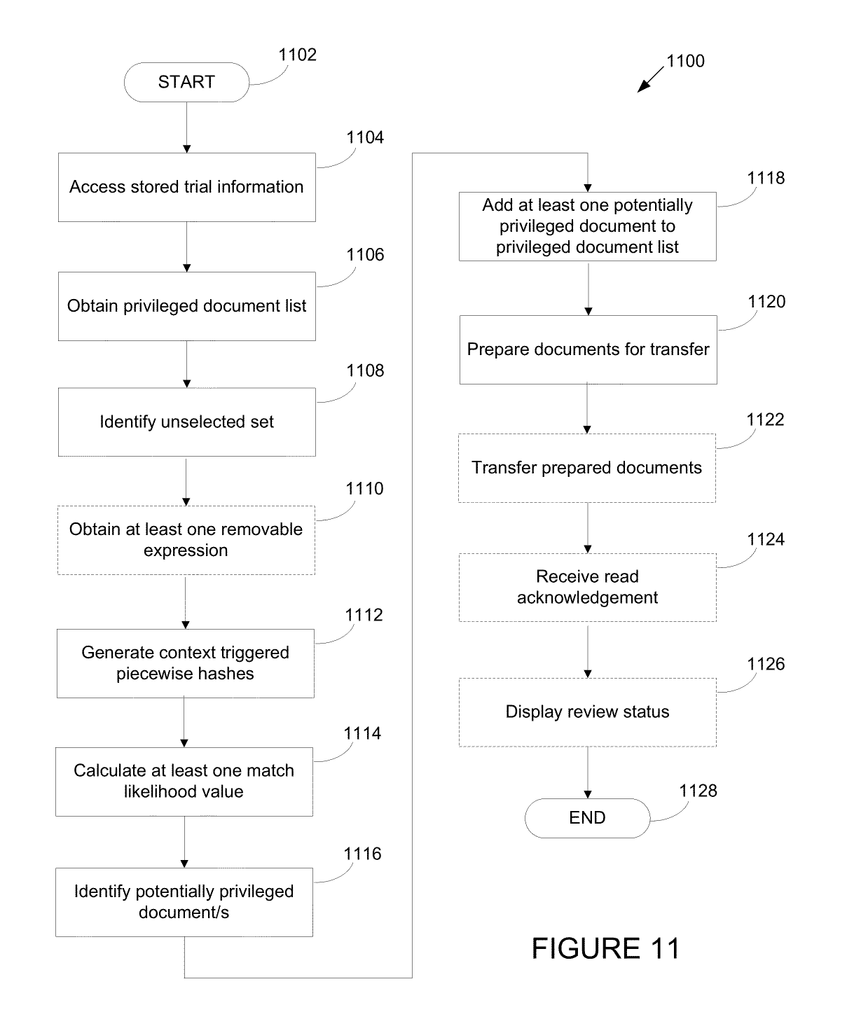

FIG. 11 illustrates a flowchart for an exemplary method for managing trial information in accordance with one or more systems and/or methods for detecting documents described herein. Process 1100 begins at step 1102.

Processing continues to step 1104, where stored trial information is accessed. The stored trial information includes a plurality of documents in a digital format. In one or more embodiments, the stored trial information includes documents relevant to a litigation proceeding. For example, the stored trial information may include documents that are responsive to one or more discovery requests. The stored trial information may be stored and managed by a trial management system, such as a trial management system configured to assist with electronic discovery.

The stored trial information may include data generated using one or more digital forensics analysis techniques. The stored trial information may include any document format suitable for production, including scanned documents, electronic correspondence, digital attachments, photographs, videos, multi-media files, database files, and any other digitized format suitable for production in electronic discovery. The stored trial information may further include metadata associated with one or more documents.

Processing continues to step 1106, where a privileged document list is obtained. The privileged document list identifies a selected set of the plurality of documents that are marked and/or otherwise identified as privileged. In one or more embodiments, the privileged document list is obtained by one or more database queries configured to return documents designated as privileged, as recorded in a database. The database may be a database associated with a trial management system configured to assist with electronic discovery.

Processing continues to step 1108, where an unselected set of documents are identified. The unselected set includes documents belonging to the plurality of documents and not belonging to said selected set. In one or more embodiments, this step is fulfilled by executing one or more database queries configured to return the relevant documents. For example, the unselected set of documents may include documents responsive to one or more discovery requests that are not designated as privileged.

Processing continues to optional step 1110, where at least one removable expression is obtained. The at least one removable expression may be obtained from a database, from one or more designated files, and/or via a user interface configured to accept input from a user, or from any other input source. The at least one removable expression includes words or phrases that are known to commonly occur in the stored trial information, such as headers, footers, notices, titles, labels, names, and other words or phrases that are repeated in the stored trial information. In one or more preferred embodiments, the at least one removable expression improves the detection of privileged documents that are not marked as privileged. The removable expressions may be added or removed to perform one or more iterations of privileged document detection to improve the detection of privileged documents.

In one or more embodiments, at least one excluded context triggered piecewise hash is calculated based on the at least one removable expression. Any excluded context triggered piecewise hashes are ignored when calculating match likelihood values between documents. Alternatively, the removable expressions may be are removed from the documents or otherwise ignored during the generation of context triggered piecewise hashes for the documents.

Processing continues to step 1112, where a plurality of context triggered piecewise hashes are generated for at least one document of the selected set and at least one document of the unselected set.

Processing continues to step 1114, where at least one match likelihood value is calculated between at least one document of the selected set and at least one document of the unselected set based on the plurality of context triggered piecewise hashes. The match likelihood values correspond to a similarity between a document designated as privileged and a document not designated as privileged. In one or more embodiments, one or more alternate or additional algorithms, heuristics or methods may be used to calculate the at least one match likelihood value.

Processing continues to step 1116, where at least one potentially privileged document in the unselected set is identified based on its match likelihood value with at least one document from the selected set corresponding to the privileged document list. In one or more embodiments, one or more threshold match likelihood values are used to determine if a document should be identified as potentially privileged. Different match likelihood values maybe used for different types or classifications of documents. For example, different threshold match likelihood values may be used for e-mail correspondence, documents known to be sensitive or otherwise important, documents marked as confidential, documents with a high match likelihood value for multiple known privileged documents, or any other scenario justifying a different threshold for evaluating privilege.

Processing continues to step 1118, where at least one potentially privileged document is added to the privileged document list. In one or more embodiments, this step is fulfilled by changing a privilege designation for the document in a database such that the document would be returned when executing one or more database queries configured to return documents designated as privileged.

In one or more embodiments, a user interface is displayed to a user to obtain user input regarding the proper designation of the potentially privileged documents. At least one potentially privileged document may be displayed to a user, and input from the user may be accepted that corresponds to at least one privilege classification for a potentially privileged document. For example, the privilege classification may include non-privileged, attorney-client privilege, attorney work product, and/or confidential. In addition to displaying potentially privileged documents, other information may be displayed, such as a match likelihood value, the one or more privileged documents that highly match the potentially privileged document, metadata associated with either the potentially privileged document and/or the known privileged document, whether either document is redacted, or any other information useful for the user to determine whether the document is privileged.

Processing continues to step 1120, where documents excluded from the modified privileged document list are prepared for transfer. In one or more embodiments, this step includes executing one or more database queries configured to return documents designated as privileged. One or more transfer options, such as the transfer options described with respect to FIG. 3, may be used in preparing the non-privileged documents for transfer.

The documents may be prepared for transfer in a specific format for electronic production. For example, the documents may be prepared in a format compatible with a third-party electronic trial management platform. The documents may also be prepared in a format compatible with a current trial management platform, such as a trial management platform that integrates the document detection systems and methods described herein. In one or more embodiments, preparing the documents for transfer includes the step of preparing at least one loadfile, which may have a proprietary or standardized format.

Processing continues to optional step 1122, where the prepared documents are transferred to a receiving party. In one or more embodiments, the receiving party has a chance to review a summary, such as a load file, corresponding to the transfer before accepting or rejecting the transfer.

Processing continues to optional step 1124, where a read acknowledgement is received from a party to whom said prepared documents are transferred. In one or more embodiments, the read acknowledgement is received after the party receiving the transfer accepts the transfer.

Processing continues to optional step 1126, where displaying a review status based on said read acknowledgement. In one or more embodiments, the review status indicates whether the transfer has been accepted by the party receiving the transfer.

Processing continues to step 1128, where process 1100 terminates.

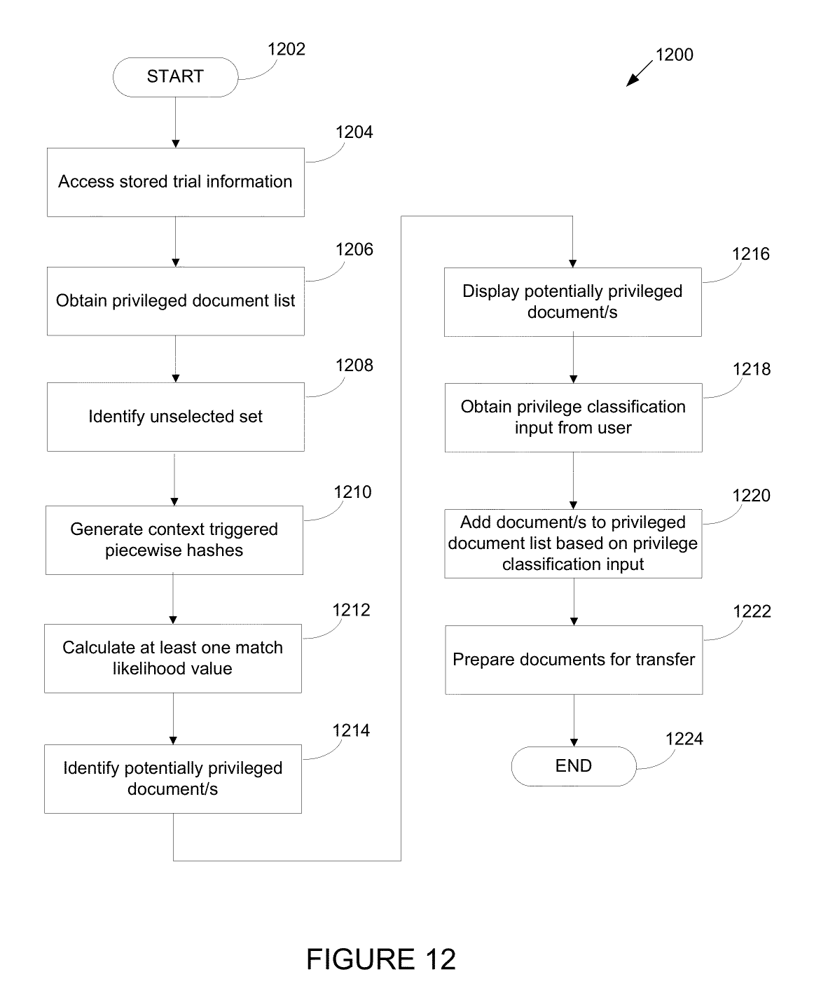

FIG. 12 illustrates a flowchart for an exemplary method for managing trial information in accordance with one or more systems and/or methods for detecting documents described herein. Process 1200 begins at step 1202.

Processing continues to step 1204, where stored trial information comprising a plurality of documents in a digital format is accessed.

Processing continues to step 1206, where a privileged document list is obtained. The privileged document list identifies a selected set of the plurality of documents including documents identified as privileged. In one or more embodiments, the privileged document list is obtained by one or more database queries configured to return documents designated as privileged.

Processing continues to step 1208, where an unselected set is identified. The unselected set includes documents belonging to the plurality of documents and not belonging to the selected set.

Processing continues to step 1210, where a plurality of context triggered piecewise hashes is generated for at least one document of the selected set and at least one document of the unselected set. In one or more embodiments, this step may be executed by accessing a previously generated set of context triggered piecewise hashes for at least one document.

Processing continues to step 1212, where at least one match likelihood value between said at least one document of said selected set and said at least one document of said unselected set is calculated. The at least one match likelihood value is calculated based on the plurality of context triggered piecewise hashes. In one or more embodiments, one or more alternate or additional algorithms, heuristics or methods may be used to calculate the at least one match likelihood value.

Processing continues to step 1214, where at least one potentially privileged document is identified in the unselected set based on the at least one match likelihood value with at least one document from the selected set.

Processing continues to step 1216, where the at least one potentially privileged document is displayed to a user. In addition to displaying potentially privileged documents, other information may be displayed, such as a match likelihood value, the one or more privileged documents that highly match the potentially privileged document, metadata associated with either the potentially privileged document and/or the known privileged document, whether either document is redacted, or any other information useful for the user to determine whether the document is privileged.

Processing continues to step 1218, where input corresponding to at least one privilege classification is obtained from the user. For example, the privilege classification may include non-privileged, attorney-client privilege, attorney work product, and/or confidential.

Processing continues to step 1220, where at least one of the at least one potentially privileged document is added to the privileged document list based on the at least one privilege classification. In one or more embodiments, this step is fulfilled by changing a privilege designation for the document in a database such that the document would be returned when executing one or more database queries configured to return documents designated as privileged.

Processing continues to step 1222, where documents excluded from the modified privileged document list are prepared for transfer. One or more transfer options, such as the transfer options described with respect to FIG. 3, may be used in preparing the non-privileged documents for transfer. The documents may be prepared in a format compatible with a third-party electronic trial management platform and/or a current trial management platform. In one or more embodiments, preparing the documents for transfer includes the step of preparing at least one loadfile.

Processing continues to step 1224, where process 1200 terminates.

While the invention herein disclosed has been described by means of specific embodiments and applications thereof, numerous modifications and variations could be made thereto by those skilled in the art without departing from the scope of the invention set forth in the claims.

What is claimed is:

1. A method for managing trial information comprising:
accessing stored trial information comprising a plurality of documents in a digital format;
obtaining a privileged document list identifying a selected set of said plurality of documents comprising documents identified as privileged;
identifying an unselected set comprising documents belonging to said plurality of documents and not belonging to said selected set;
generating a plurality of context triggered piecewise hashes for at least one document of said selected set and at least one document of said unselected set;
calculating at least one match likelihood value between said at least one document of said selected set and said at least one document of said unselected set based on said plurality of context triggered piecewise hashes;
identifying at least one potentially privileged document in said unselected set based on said at least one match likelihood value with at least one document from said selected set;
adding at least one of said at least one potentially privileged document to said privileged document list; and
preparing documents excluded from said modified privileged document list for transfer.

2. The method of claim 1, further comprising:
displaying said at least one potentially privileged document to a user; and
obtaining input from said user corresponding to at least one privilege classification,
wherein adding said at least one potentially privileged document to said privileged document list is based on said at least one privilege classification.

3. The method of claim 2, wherein said at least one privilege classification comprises an indicator selected from the indicator set comprising non-privileged, attorney-client privilege and attorney work product.

4. The method of claim 3, wherein said indicator set further comprises confidential.

5. The method of claim 1, wherein preparing said documents comprises preparing said documents in a specified format for electronic production.

6. The method of claim 5, wherein said specified format is compatible with a third-party electronic trial management platform.

7. The method of claim 1, further comprising transferring said prepared documents.

8. The method of claim 7, further comprising:
receiving a read acknowledgement from a party to whom said prepared documents are transferred; and
displaying a review status based on said read acknowledgement.

9. The method of claim 1, further comprising:
obtaining at least one removable expression; and
calculating at least one excluded context triggered piecewise hash based on said at least one removable expression,
wherein said at least one excluded context triggered piecewise hash is ignored when calculating said at least one match likelihood value between said at least one document of said selected set and said at least one document of said unselected set.

10. The method of claim 1, further comprising:
obtaining at least one removable expression,
wherein said at least one removable expression is excluded when generating said plurality of context triggered piecewise hashes for said at least one document of said selected set and said at least one document of said unselected set.

11. A computer readable medium comprising computer readable instructions for managing trial information, wherein execution of said computer readable instructions by one or more processors causes said one or more processors to:
access stored trial information comprising a plurality of documents in a digital format;
obtain a privileged document list identifying a selected set of said plurality of documents comprising documents identified as privileged;
identify an unselected set comprising documents belonging to said plurality of documents and not belonging to said selected set;
generate a plurality of context triggered piecewise hashes for at least one document of said selected set and at least one document of said unselected set;
calculate at least one match likelihood value between said at least one document of said selected set and said at least one document of said unselected set based on said plurality of context triggered piecewise hashes;
identify at least one potentially privileged document in said unselected set based on said at least one match likelihood value with at least one document from said selected set;
display said at least one potentially privileged document to a user; and
obtain input from said user corresponding to at least one privilege classification,
add at least one of said at least one potentially privileged document to said privileged document list based on said at least one privilege classification; and
prepare documents excluded from said modified privileged document list for transfer.

12. The computer readable medium of claim 11, wherein said at least one privilege classification comprises an indicator selected from the indicator set comprising non-privileged, attorney-client privilege and attorney work product.

13. The computer readable medium of claim 12, said indicator set further comprises confidential.

14. The computer readable medium of claim 11, wherein preparing said documents comprises preparing said documents in a specified format for electronic production.

15. The computer readable medium of claim 11, wherein said specified format is compatible with a third-party electronic trial management platform.

16. The computer readable medium of claim 15, wherein execution of said computer readable instructions by one or more processors further causes said one or more processors to securely transfer said prepared documents to another party registered with said third-party electronic trial management platform.

17. The computer readable medium of claim 11, wherein execution of said computer readable instructions by one or more processors further causes said one or more processors to:
securely transfer said prepared documents to another party.

18. The computer readable medium of claim 17, wherein execution of said computer readable instructions by one or more processors further causes said one or more processors to:
receive a read acknowledgement from said party to whom said prepared documents are transferred; and
display a review status based on said read acknowledgement.

19. The computer readable medium of claim 11, wherein execution of said computer readable instructions by one or more processors further causes said one or more processors to:
obtain at least one removable expression; and
calculate at least one excluded context triggered piecewise hash based on said at least one removable expression,
wherein said at least one excluded context triggered piecewise hash is ignored when calculating said at least one match likelihood value between said at least one document of said selected set and said at least one document of said unselected set.

20. The computer readable medium of claim 11, wherein execution of said computer readable instructions by one or more processors further causes said one or more processors to:
obtain at least one removable expression,
wherein said at least one removable expression is excluded when generating said plurality of context triggered piecewise hashes for said at least one document of said selected set and said at least one document of said unselected set.
